(19) United States
(12) Patent Application Publication
(10) Pub. No.: US 2026/0124853 A1
(43) Pub. Date: May 7, 2026

(54) METHOD FOR MANUFACTURING A DECORATIVE PART

(71) Applicant: JOYSONQUIN Automotive Systems GmbH, Rutesheim (DE)

(72) Inventor: Liesa GUNTHER, Pforzheim (DE)

(21) Appl. No.: 19/379,953

(22) Filed: Nov. 5, 2025

(30) Foreign Application Priority Data
Nov. 6, 2024 (DE) 102024132297.7

(51) Int. Cl. B44C 5/00

(52) U.S. Cl. CPC B44C 5/00

(57) ABSTRACT

A method for manufacturing a decorative part for the interior of a vehicle with a decorative layer, for example made of wood veneer, aluminum, or foil, which can be printed in one or more colors after a material-specific pretreatment using an ink printing method such as a DOS or CIJ method.

### FIELD OF THE INVENTION

The present invention relates to a method for manufacturing a decorative part for the interior of a vehicle, in particular a motor vehicle.

### BACKGROUND OF THE INVENTION

U.S. Pat. No. 11,679,614 B2 discloses a method for manufacturing a decorative part for the interior of a vehicle. Here, a special resist coating is applied to a decorative layer formed from a metal sheet using a digital printing process and, after application of the resist coating, this is reworked by brushing, whereby the resist coating resists this mechanical reworking. This allows special designs to be produced for a decorative part. It has been found that the approach described in U.S. Pat. No. 11,679,614 B2 is not readily suitable for applying general paint or other printing inks to a decorative layer of the decorative part. In particular, when inks that are not resist varnishes are applied, the quality of the printed images is inferior. However, there is a need to be able to use digital printing processes more widely in the manufacture of decorative parts for the interior of a vehicle.

### SUMMARY OF THE INVENTION

Based on this, the present invention is based on the task of specifying a method that enables the printing of different decorative layers for the production of decorative parts for the interior of a vehicle using a digital printing method.

To solve this problem, a method for manufacturing a decorative part for a vehicle interior is proposed, comprising the following steps:
a) providing a decorative layer made of a material;
b) pretreating a front side of the decorative layer in a manner suitable for the material to enable printing on the front side;
c) printing the front side using an ink printing process;
d) optionally, trimming the decorative layer;
e) preforming a decorative element from the decorative layer;
f) back-injection molding of the decorative element with a plastic on a rear side opposite the front side;
g) painting the front side.

Depending on the material available, which may be wood, aluminum, or plastic in the form of a film, step b) involves pretreating a front side of the decorative layer. Preferred examples of this pretreatment are described in more detail below. It has also been found that, of the digital printing processes, the ink printing process is best suited for printing decorative layers, especially those made of wood, aluminum, or plastic. With the appropriate inks and the aforementioned pretreatment, it is possible to print decorative layers regardless of the material, and the print image and thus also the corresponding decorative parts can meet the strict requirements of the automotive industry.

After pretreating the front side of the decorative layer, which after completion forms the visible side of the decorative part, and printing the front side in step c), the decorative layer can be trimmed in step d). Alternatively, a decorative layer that has already been cut can be provided in step a). In principle, according to the present invention, it is also possible to process the decorative layer before step b), in particular to make one or more holes, to mill the decorative layer, to treat the decorative layer with a laser, and/or to cut it.

In step e), the decorative layer is deformed to form a decorative element. Preferably, this involves three-dimensional deformation of the essentially flat decorative layer. The decorative element is back-injected, preferably with a plastic comprising at least one of the following materials: polyolefins, polypropylene (PP), polymethyl methacrylate (PMMA), polycarbonate (PC), polystyrene (PS) and its copolymers, such as in particular acrylonitrile butadiene styrene (ABS), polyamide (PA) and/or polyoxymethylene (POM), stabilizes the decorative element and thus forms the body of the decorative part, which is completed by painting the front side. In this case, fastening elements can be formed on the rear side of the decorative part opposite the decorative layer, by means of which the decorative part can be fixed in the vehicle interior. Alternatively or additionally, structures can also be formed here by means of which light can be introduced into the substrate formed by the plastic during back molding.

The term inkjet printing process refers to printing processes in which liquid ink is applied to the front side of the decorative layer, for example as drops using the DOD (drop on demand) process or from an ink jet using the CIJ (continuous ink jet) process. In the DOD process, individual ink droplets are applied to the region to be printed, whereby, for example, ink droplets are heated via a heating element to form a vapor bubble for discharging the ink droplet (“bubble jet process”), ink droplets are discharged via a piezoelectric element, or valves are used to control individual nozzles, which open when a droplet is to leave the nozzle (pressure valve method). In the CIJ process, at least one ink jet is generated in which a uniform breakdown into individual drops is produced. The drops formed are directed to the region to be printed via a targeted electrostatic charge.

The method according to the invention allows decorative layers for decorative parts to be printed using ink printing methods. This enables the creation of complex designs on the front side of the decorative layer, which cannot be achieved with the same quality using screen printing methods. Symbols, design elements, and the like can be printed onto the decorative element. Printing can be done in one or more colors.

According to one embodiment, the material is wood and the decorative layer is a wood veneer. A wood veneer is understood to be a sheet of wood, which in particular has a thickness of approximately 0.5 to 8 mm [millimeters], which has been separated from a log by a sawing or cutting process. Wood veneers with a thickness of 0.6 to 0.9 mm are preferred, the thickness of which after manufacture of the decorative part is preferably in the range of 0.4 to 0.6 mm, in particular after corresponding sanding of the wood veneer. These thicknesses allow easy and efficient handling of the decorative layer and at the same time create a decorative part that is durable. In particular, a backlit decorative layer can be produced that can be illuminated from behind. A decorative part with a decorative layer made of wood veneer is visually appealing and creates a high-quality impression. At the same time, wood veneer has a low weight per unit area due to its density and low thickness. This allows lightweight decorative parts to be formed.

Preferably before step c) and preferably before step b), the back of the decorative layer is sanded. This improves the adhesion of the plastic in step f) and the bond with the decorative layer. At the same time, any deviations exceeding the tolerance range can be compensated for. If a laminate is to be applied to the reverse side, grinding the reverse side is preferable as this improves the adhesion of the laminate and simplifies the bonding to the laminate.

In this context, it is preferable that, after sanding the back of the decorative layer, the back is laminated with a nonwoven fabric, in particular a cellulose and/or polyester nonwoven fabric, and in particular that the nonwoven fabric is glued to the back of the decorative layer. This allows stresses in the wood veneer to be absorbed and the wood veneer to be reinforced. At the same time, good adhesion to the plastic is achieved during back spraying in step f). Sanding the back of the decorative layer allows a good bond with the fleece to be achieved. The fleece is preferably bonded to the back of the decorative layer using a thermoplastic or thermosetting adhesive system.

It is preferable to sand the front side of the decorative layer before step c) and especially before step b). This further improves the print image during printing in step c). At the same time, the thickness of the wood veneer can be adjusted.

It is preferable to dye the front side before step c) and, in particular, after sanding the front side, and then to temper it. Tempering refers to the process of tempering the wood veneer according to a predetermined temperature curve. In this process, the wood veneer is heated in a controlled manner and then cooled again after heating. For example, the decorative layer is heated to a maximum temperature in the range of 40 to 45° C. [degrees Celsius]. When coloring the front side, solvent-based stains are used in particular, especially if a UV-based or solvent-based ink is used as the ink, and a water-based stain is used if a water-based ink is used as the ink.

Preferably, the front side is treated in step b), in particular immediately before step c), in particular after completion of the coloring and tempering, to increase the surface tension of the front side, in particular by means of plasma treatment and/or corona treatment. It has been found that increasing the surface tension on the front side of the decorative layer can improve the adhesion of the ink to the wood veneer, both for water-based inks, solvent-based inks (which contain solvents other than water, in particular organic solvents) and for inks that can be cured by ultraviolet radiation (UV-curable inks) with a well-defined print image.

Preferably, the surface tension is increased to values of at least 38 dyn/cm [dyn per centimeter, where one dyn corresponds to 10⁻⁵ Newton], in particular to values of at least 43 dyn/cm, and in the case of corona treatment even up to 62 dyn/cm. It has been found that increasing the surface tension to values in this range achieves good adhesion of the ink to the front side of the wood veneer.

Corona treatment refers to the surface treatment of the front side of the decorative layer using corona discharge. Plasma treatment refers to the surface treatment of the front side of the decorative layer using plasma. Corona treatment with a frequency of 15 to 25 kHz [kilohertz] and voltages of up to 80 kV [kilovolts] is preferred. [kilovolts]. Plasma treatment in particular uses atmospheric pressure plasma, in which the pressure at which it is generated corresponds approximately to that of the surrounding atmosphere, i.e., normal pressure. Plasma is defined as a partially ionized gas generated by electrical discharges such as piezoelectric direct discharge. Corona treatment is performed, for example, at a distance of 1.5 mm [millimeters] between the discharge electrode and the surface, a treatment speed of 3 meters per minute, a power of 250 W [watts] to 900 W, and a specific energy of 278 W min/m³ [watts per minute per cubic meter] to 4000 W min/m³, in particular from 278 W min/m³ to 700 W min/m³. The plasma contains charged particles, ions, and electrons that are accelerated to very high energies and, through collision with gas molecules in the air, produce large quantities of short-lived, highly reactive substances such as radicals and ozone and other molecules in metastable excited states, which then react with the surface to be treated when they strike it, chemically altering it. The plasma is preferably generated by piezoelectric direct discharges or by creating an electric arc between two electrodes using pulsed high-voltage electricity.

It is also preferable to print on the back of the decorative layer, in particular using a digital printing process, especially an inkjet process. This allows, for example, additional symbols or graphics to be applied, which become visible when the decorative layer is backlit, i.e., when light is introduced into the substrate produced by back spraying in step f). The back is preferably pretreated in the same way as specified in step b).

Preferably, the decorative element is milled after step f) but before step g) in order to enable the final shaping and size to be achieved within narrow tolerance ranges. The coating in step g) allows a defined surface of the decorative part to be achieved and protects the decorative layer from environmental influences such as moisture or grease, which could smudge the ink applied in step c). At the same time, the printing is protected from wear and tear.

According to a further embodiment, the material comprises aluminum. In particular, the decorative layer is made of aluminum or an aluminum alloy. Corresponding aluminum decorations are often perceived as high-quality. In addition, decorative layers made of aluminum are relatively light and easy to process. The decorative layer is preferably provided in the form of sheets or in the form of a rolled coil. It is preferable to carry out steps a) to c) on the sheet or rolled coil and, after step c), to specify the shape and dimensions of the decorative layer by cutting it to size in step d).

In this context, step b) preferably comprises at least one of the following treatments:
A. a wet chemical treatment;
B. electrolytic oxidation;
C. a plasma treatment;
D. a corona treatment; and
E. application of a bonding agent.

Corona treatment with a frequency of 15 to 25 kHz [kilohertz] and voltages up to 80 kV [kilovolts] is preferred. The corona treatment is performed, for example, at a distance of 1.5 mm [millimeters] between the discharge electrode and the surface, a treatment speed of 3 meters per minute, a power of 250 W [watts] to 900 W, and a specific energy of 278 W min/m³ [watts per minute per cubic meter] to 4000 W min/m³, in particular from 278 W min/m³ to 700 W min/m³.

Plasma treatment involves the use of atmospheric pressure plasma in particular, in which the pressure at which it is generated corresponds approximately to that of the surrounding atmosphere, i.e., normal pressure. Plasma is defined as a partially ionized gas generated by electrical discharges such as piezoelectric direct discharge. The plasma contains charged particles, ions, and electrons, which are accelerated to very high energies and, through collision with gas molecules in the air, produce large quantities of short-lived, highly reactive substances such as radicals and ozone and other molecules in metastable excited states, which then react with the surface to be treated when they strike it, causing chemical changes. The plasma is preferably generated by piezoelectric direct discharges or by creating an electric arc between two electrodes using pulsed high-voltage electricity. In wet chemical treatment, the surface is preferably first degreased in alkaline aqueous solutions and then preferably pickled in an alkaline or acidic pickling bath. A polyurethane-based bonding agent is preferably used as the bonding agent. These treatments increase the surface tension on the front side of the decorative layer. This improves the adhesion of the ink in step c), so that a precise print image can be achieved.

In the case of a decorative layer made of a material comprising aluminum, a milling treatment may preferably be carried out after step f) and before step g). This allows the geometry and shape of the final decorative part to be influenced.

Preferably, the decorative layer is laminated on the reverse side after step c), preferably with a material comprising polyethylene, in particular high-density polyethylene, and/or thermoplastic polyurethane.

Preferably, the surface tension is increased to values in the range of at least 38 dyn/cm and particularly preferably to at least 43 dyn/cm. It has been found that increasing the surface tension to values in this range achieves good adhesion of the ink to the front side of the aluminum.

According to a further embodiment, the material comprises a film, in particular a plastic film, which is particularly preferably formed from at least one of the following materials: a polycarbonate (PC), a polyethylene terephthalate (PET), a polybutylene terephthalate (PBT), an acrylonitrile-butadiene-styrene copolymer (ABS), a polyurethane (PU), and/or a metal, in particular aluminum and/or copper.

In this context, step b) particularly preferably comprises at least one of the following treatments:
i) a Plasma Treatment;
ii) a corona treatment; and
iii) application of a bonding agent.

Corona treatment with a frequency of 15 to 25 kHz [kilohertz] and voltages up to 80 kV [kilovolts] is preferred. The corona treatment is carried out, for example, at a distance of 1.5 mm [millimeters] between the discharge electrode and the surface, a treatment speed of 3 meters per minute, a power of 250 W [watts] to 900 W, and a specific energy of 278 W min/m³ [watts per minute per cubic meter] to 4000 W min/m³, in particular from 278 W min/m³ to 700 W min/m³.

Plasma treatment involves the use of atmospheric pressure plasma in particular, in which the pressure at which it is generated corresponds approximately to that of the surrounding atmosphere, i.e., normal pressure. Plasma is defined as a partially ionized gas generated by electrical discharges such as piezoelectric direct discharge. The plasma contains charged particles, ions, and electrons, which are accelerated to very high energies and, through collision with gas molecules in the air, produce large quantities of short-lived, highly reactive substances such as radicals and ozone and other molecules in metastable excited states, which then react with the surface to be treated when they strike it, causing chemical changes. The plasma is preferably generated by piezoelectric direct discharges or by creating an electric arc between two electrodes using pulsed high-voltage electricity. A solvent-based bonding agent based on polyurethane is preferred as the bonding agent here. Plasma treatment and corona treatment increase the surface tension of the film, improving the adhesion of the ink to the surface. The same result is achieved by treatment with the bonding agent. This results in a well-defined print image.

It is also preferable to print on the reverse side of the film, in particular using a digital printing process, preferably an ink printing process. This allows, for example, additional symbols or graphics to be applied which become visible when the decorative layer is backlit, i.e. when light is introduced into the substrate produced by back spraying in step f). The reverse side can be pretreated in accordance with step b).

In step b), it is preferable to increase the surface tension to values in the range of at least 38 dyn/cm, particularly preferably at least 43 dyn/cm. It has been found that increasing the surface tension to values in this range achieves good adhesion of the ink to the front side of the film.

Regardless of the material used for the decorative layer, it is preferable to use one of the following inks:
I. a water-based ink;
II. a solvent-based ink; and
III. a UV-curing ink.

The above-mentioned material-specific pretreatments allow the aforementioned inks to be used. This allows for a wide variety of ink choices and the resulting printing options. The use of water-or solvent-based inks is preferred if the decorative layer is to remain visible under the ink. The use of UV-curing ink is preferred if an opaque print is to be produced in step c), under which the decorative layer is no longer visible. In addition, printing with UV-curing ink saves time compared to printing with water-or solvent-based ink, as the drying times are significantly shorter. For a decorative layer made of wood veneer, solvent-based ink is preferred, as it causes only minimal raising of the wood fibers.

Regardless of the material used for the decorative layer, it is preferable that the decorative element be machined, in particular milled, between steps f) and g). This allows both final shaping and adjustment to specified tolerance limits.

### BRIEF DESCRIPTION OF THE DRAWINGS

Further details and advantages of the present invention are apparent from the following description of an embodiment in conjunction with the drawing. This shows schematically:

FIG. 1: an example of a decorative part;

FIG. 2: an example of a decorative element with lamination;

FIG. 3: a process flow for the production of a decorative part from a decorative layer made of wood veneer;

FIG. 4: a process flow for the production of a decorative part from a decorative layer made of aluminum; and

FIG. 5: a process flow for manufacturing a decorative part from a decorative layer made of foil.

### DETAILED DESCRIPTION OF THE PREFERRED EMBODIMENTS

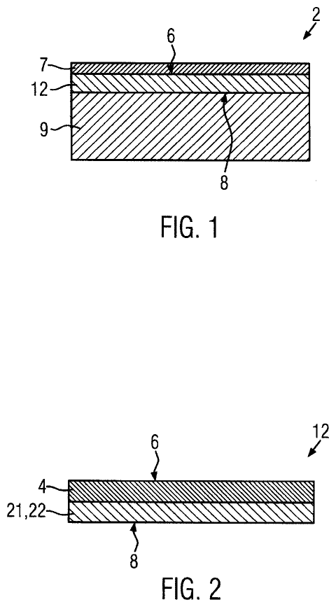

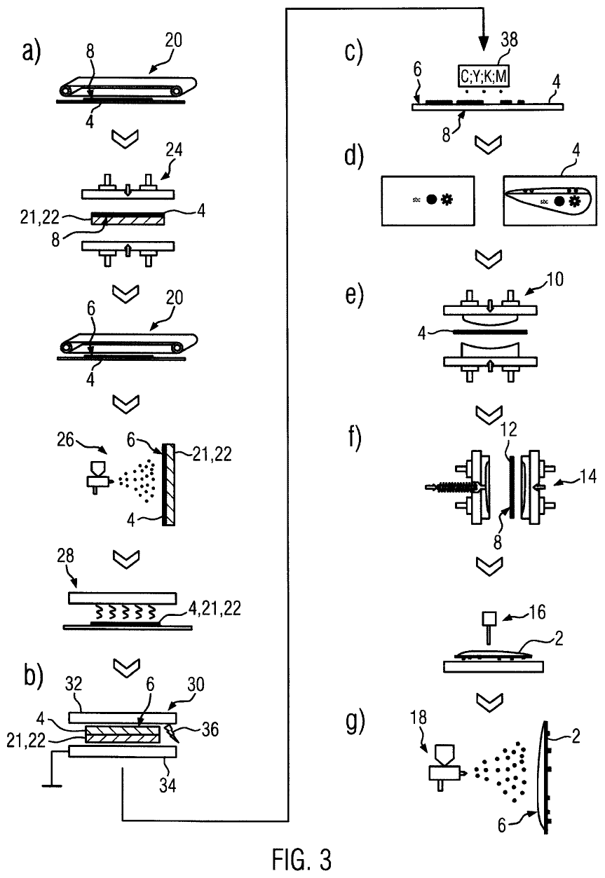

FIG. 1 shows an example of a decorative part 2 for the interior of a vehicle, in particular a motor vehicle, which has been manufactured according to the method presented here. The decorative part 2 comprises a decorative element 12, which comprises a decorative layer 4 (see FIG. 2). The decorative layer 4 and the decorative element 12 have a front side 6 which, as explained below with reference to FIGS. 3 to 5, is printed using an ink printing process after a material-specific pretreatment. On the front side 6 of the decorative element 12, the decorative element 2 has a lacquer layer 7 which protects the front side 6 of the decorative element 12, in particular from environmental influences and wear. Opposite the front side 6, the decorative element 12 has a rear side 8 that is bonded to a plastic substrate 9, which is injection molded onto the decorative element 12 in process step f).

FIG. 2 shows an example of a decorative element 12, which is provided with the decorative layer 4 and a laminate 21 formed as a nonwoven fabric 22 on a side opposite the front side 6. A cellulose and/or polyester nonwoven fabric is preferably used as the nonwoven fabric 22. The laminate stabilizes the decorative layer 2 in particular and facilitates the injection molding of the substrate 9. The laminate 21 is bonded to the decorative layer 4, preferably by means of a thermoplastic or thermosetting adhesive system.

In the present method, the decorative layer 4 is preferably formed from a wood veneer, aluminum, or a film, in particular a plastic film. In principle, in all the process sequences shown here, it is also possible and preferable to process the decorative layer before step b), in particular to drill one or more holes, to mill the decorative layer, to treat the decorative layer with a laser, and/or to trim it.

FIG. 3 shows a preferred process sequence for a decorative layer 4 made of wood veneer. Individual process steps are separated and connected by arrows that demonstrate the sequence of events.

In a first process step a), a decorative layer 4 made of wood veneer is provided. For this purpose, the rear side 8 of the decorative layer 4 is first sanded with a sanding tool 20. Subsequently, a laminate 21 is bonded to the rear side 8 of the decorative layer 4 in a laminating tool 24 using a thermoplastic or thermosetting adhesive system. The laminate 21 is made of a cellulose or plastic fleece or nonwoven fabric 22. The front side 6 of the decorative layer 4 is then sanded in a sanding tool 20 and subsequently dyed in a dyeing tool 26. A solvent-based stain is preferred as the dye if a solvent-based or UV-curable ink is used in step c). If a water-based ink is used in step c), the use of a water-based stain is preferred. The decorative layer 4 with lamination 21 is then tempered in a heating device 28. Here, the decorative layer 4 together with lamination 21 is subjected to a predeterminable tempering curve so that the color applied in the previous step dries and diffuses into the wood of the decorative layer 4.

In process step b), the front side 6 of the decorative layer 4 is pretreated in a manner appropriate to the material. For this purpose, the decorative layer 4 with lamination 21 is placed in a corona treatment unit 30, which comprises a high-voltage electrode 32 and a ground electrode 34. During operation, the high-voltage electrode 32 is operated with an alternating voltage of, for example, 10 to 20 kV [kilovolts] at a frequency of, for example, between 10 and 60 kHz [kilohertz], which leads to electrical discharges 36, symbolically represented as lightning bolts, which cause a surface modification of the front side 6 of the decorative layer 4, resulting in increased surface tension on the front side 6 of the decorative layer 4.

The decorative layer 4 prepared in this way is printed in process step c) using an ink printing process. Here, ink is applied to the areas to be printed on the front side 6 of the decorative layer 4 via a print head 38 using an ink printing process, in particular a DOD or CIJ process. Printing can be done in one or more colors.

In process step d), the decorative layer 4 can be trimmed if necessary. In process step e), a preferably flat decorative layer 4 is preformed into a particularly three-dimensional decorative element 12 in a preforming tool 10.

In the subsequent process step f), the decorative element 12 is back-injected on the rear side 8 of the decorative element 12 with a plastic to form a decorative part 2. This forms the substrate 9 shown in FIG. 1. This is followed by milling finishing with a milling tool 16. In process step g), paint is applied to the front side 6 of the decorative layer 4 and thus of the decorative part 2 using a painting tool 18, which protects the front side 6.

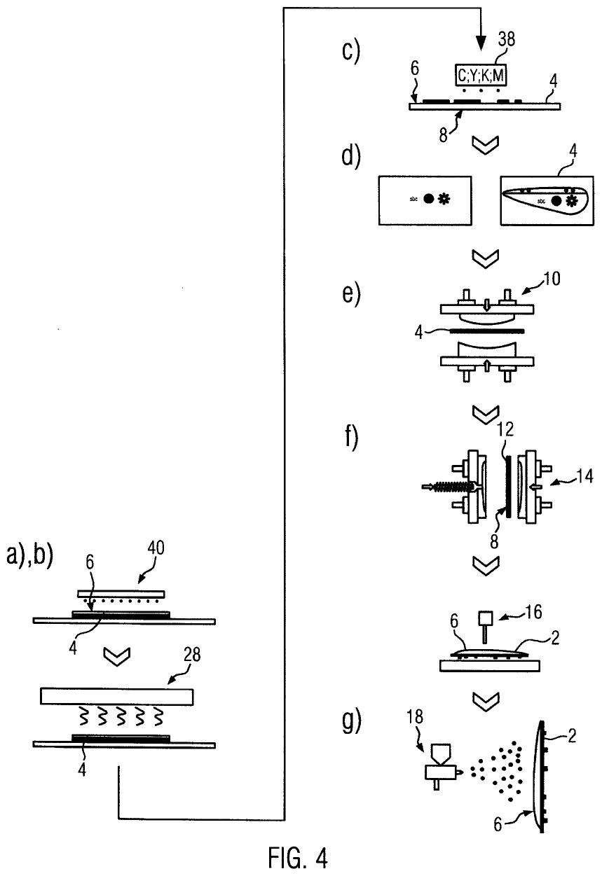

FIG. 4 shows an example of a process sequence for the production of a decorative part 2 with a decorative layer 4 made of aluminum. In process step a), the decorative layer 4 is provided and, in process step b), the front side 6 of the decorative layer 4 is subjected to a pretreatment to enable printing on the front side 4. For this purpose, an adhesion promoter, in this example a polyurethane-based adhesion promoter, is applied to the entire surface of the front side 6 of the decorative layer 4 by means of a wetting unit 40. The decorative layer 4 wetted with the bonding agent is heated in a heating device 28 until the bonding agent has dried. The bonding agent ensures that the front side 6 of the decorative layer 4 can be printed on easily.

In the subsequent process step c), the front side 6 of the decorative layer 4 is printed at least in some areas using an ink printing process, in particular a DOD or CIJ process. This is preferably followed by a rear lamination of the decorative layer 4, which is not shown in FIG. 4, before the printed decorative layer 4 is trimmed in process step d), if necessary.

In the subsequent process step e), the flat decorative layer 4 is preformed in a preforming tool 10 into a preferably three-dimensional decorative element 12, which is then back-injected with plastic in a process step f) in a injection mold 14 on a rear side 8 with plastic, thus forming the decorative part 2, which is preferably subsequently machined with a milling tool 16 and thus obtains its final shape and dimensions. In process step g), the front side 6 of the decorative layer 4 and thus of the decorative part 2 is coated with paint using a painting tool 18 in order to protect the front side 6.

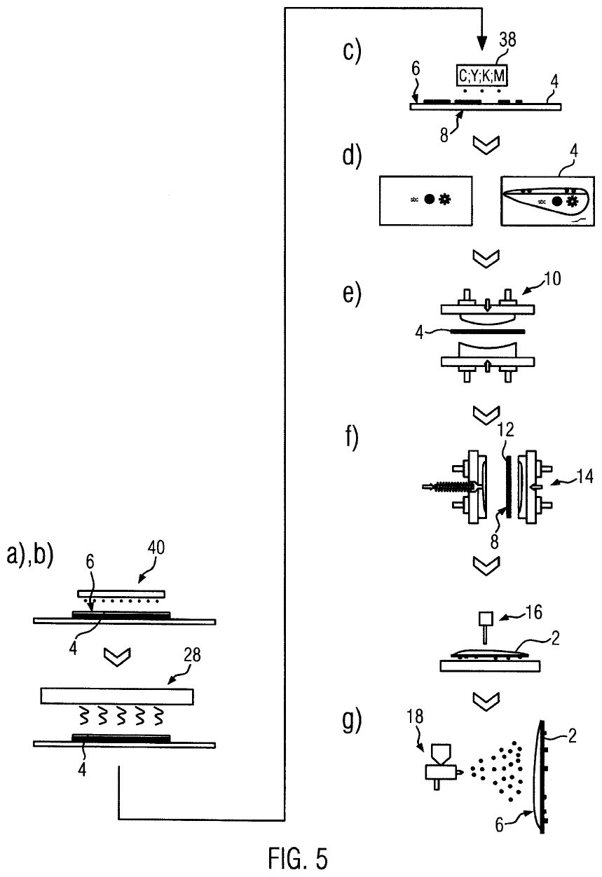

FIG. 5 shows an example of a process sequence for the production of a decorative part 2 with a decorative layer 4 made of film, in particular a film made of polycarbonate (PC), polyethylene terephthalate (PET), polybutylene terephthalate (PBT), acrylonitrile butadiene styrene copolymer (ABS) and/or polyurethane (PU). In process step a), the decorative layer 4 is provided and, in process step b), the front side 6 of the decorative layer 4 is subjected to a pretreatment to enable printing on the front side 4. For this purpose, a bonding agent, in this example a polyurethane-based bonding agent, is applied to the entire surface of the front side 6 of the decorative layer 4 by means of a wetting unit 40. The decorative layer 4 wetted with the bonding agent is heated in a heating device 28 until the bonding agent has dried. The bonding agent ensures that the front side 6 of the decorative layer 4 can be printed on easily.

In the subsequent process step c), the front side 6 of the decorative layer 4 is printed at least in some areas using an ink printing process, in particular a DOD or CIJ process. In process step d), the printed decorative layer 4 is trimmed if necessary.

In the subsequent process step e), the flat decorative layer 4 is preformed in a preforming tool 10 into a preferably three-dimensional decorative element 12, which is then back-injected with plastic in a process step f) in a injection mold 14 on a rear side 8 with plastic, thus forming the decorative part 2, which is preferably subsequently machined with a milling tool 16 and thus obtains its final shape and dimensions. In process step g), the front side 6 of the decorative layer 4 and thus of the decorative part 2 is coated with paint using a painting tool 18 in order to protect the front side 6.

The present method allows the production of a decorative part 2 for the interior of a vehicle with a decorative layer 4 made, for example, of wood veneer, aluminum, or foil, which can be printed in one or more colors after a material-specific pretreatment using an ink printing method such as a DOS or CIJ method.

### LIST OF REFERENCE SYMBOLS

2 decorative part
4 decorative layer
6 front side
7 lacquer layer
8 rear side
9 substrate
10 preform tool
12 decorative element
14 injection mold
16 milling tool
18 painting tool
20 grinding tool
21 lamination
22 nonwoven fabric
24 laminating tool
26 dyeing tool
28 heating device
30 corona treatment unit
32 high-voltage electrode
34 ground electrode
36 electrical discharge
38 print head
40 wetting unit

What is claimed is:

1. Method for manufacturing a decorative part for a vehicle interior, comprising the following steps:
a) providing a decorative layer made of a material;
b) pretreating a front side of the decorative layer in a manner suitable for the material to enable printing on the front side;
c) printing the front side using an ink printing process;
d) if necessary, trimming the decorative layer;
e) preforming a decorative element from the decorative layer;
f) back-injection molding of the decorative element with a plastic on a rear side opposite the front side; and
g) Painting the front side.

2. Method according to claim 1, wherein:
the material is wood and the decorative layer is a wood veneer.

3. Method according to claim 2, wherein:
before step c) or before step b), the rear side of the decorative layer is sanded.

4. Method according to claim 3, wherein;
after sanding the rear side of the decorative layer, the rear side is laminated with a nonwoven fabric, in particular a cellulose and/or polyester nonwoven fabric, in particular the nonwoven fabric is bonded to the rear side of the decorative layer.

5. Method according to claim 2, wherein:
prior to step c), the front side of the decorative layer is sanded.

6. Method according to claim 2, wherein:
the front side is treated in step b), in particular immediately before step c), to increase the surface tension of the front side, in particular by means of plasma treatment and/or corona treatment.

7. Method according to claim 1, wherein:
the material comprises aluminum.

8. Method according to claim 7, wherein:
step b) comprises at least one of the following treatments:
A. a wet chemical treatment;
B. electrolytic oxidation;
C. a plasma treatment;
D. a corona treatment; and
E. application of a coupling agent.

9. Method according to claim 1, wherein:
the material comprises a film, in particular a plastic film.

10. Method according to claim 9, wherein:
step b) comprises at least one of the following treatments:
i) a plasma treatment,
ii) a corona treatment; and
iii) application of a bonding agent.

11. Method according to claim 9, wherein:
the rear side of the film is printed, in particular using a digital printing method, preferably an ink printing method.

12. Method according to claim 1, wherein:
one of the following inks is used:
I. a water-based ink;
II. a solvent-based ink; and
III. a UV-curing ink.

13. Method according to claim 1, wherein:
between steps f) and g), the decorative element is machined, in particular by milling.

14. Method according to claim 10, wherein:
the rear side of the film is printed, in particular using a digital printing method, preferably an ink printing method.

15. A method for manufacturing a decorative part for a vehicle interior, comprising the steps of:
providing a decorative layer made of a material;
pretreating a side of the material of the decorative layer by increasing the surface tension of the material on the side, whereby adhesion of printing on the side is improved;
printing on the side using an ink printing process; and
forming the decorative part comprising the decorative layer in a shape configured for installation in a vehicle interior.
